(19) United States
(12) Patent Application Publication
(10) Pub. No.: US 2021/0150586 A1
(43) Pub. Date: May 20, 2021

(54) METHOD OF AND SYSTEM FOR REWARDING PARTICIPANTS FOR DIRECT ENGAGEMENT IN AN ENHANCED COMMUNICATION AND REMITTANCE NETWORK

(71) Applicant: Hieu Trung Tran, San Jose, CA (US)

(72) Inventor: Hieu Trung Tran, San Jose, CA (US)

(21) Appl. No.: 16/624,252

(22) PCT Filed: Jun. 18, 2018
(86) PCT No.: PCT/US18/38110

§ 371 Date: Dec. 18, 2019

Related U.S. Application Data
(60) Provisional application No. 62/521,495, filed on Jun. 18, 2017.

(51) Int. Cl. G06Q 30/02

(52) U.S. Cl. CPC G06Q 30/0276; G06Q 30/0271; G06Q 30/0267; G06Q 30/0217; G06Q 30/0224; G06Q 30/0209; G06Q 30/0215

(57) ABSTRACT

A method and system enable a user to choose brand contents to engage in communication transaction and be directly rewarded by a content provider (e.g., an advertiser). An advertiser creates a campaign specifying advertisement targeting preferences and offers. A registered user provides information about the user's engagement preference. A registered user initiates a communication transaction, and provides information about the intended recipient, type, amount, denomination, and content of the communication. A server system uses a remittance request and a sending user's engagement preference to generate a list of matching offers associated with the most relevant campaigns' targeting preferences. A sending user chooses the most suitable match. A receiving user receives and views the transaction, and decides whether to accept or decline the transaction. Upon receiving an acceptance, a server system transmits rewards associated with the offer from the campaign account to the sending and receiving users.

### TECHNICAL FIELD

The present disclosure relates to a computer-based method of and system for enhancing end-users' remittance and communication activities with advertisement contents, more particularly from advertisers, and to a method of and system for rewarding the users directly for their engagement.

### BACKGROUND INFORMATION

At present, digital advertising targets either the end-user's data consumption experience (e.g., search advertising, display advertising, mobile advertising, video advertising, or combinations thereof), or the user's social activities (e.g., social advertising).

Search advertising, also referred to as paid search, helps businesses advertise on search engines such as Google, Bing, and Yahoo!. Search advertising allows companies to target keywords that are relevant to their businesses and gain more prominent positioning in search engine results, thereby providing them visibility with users who are already searching for those keywords.

Display advertising helps companies advertise on a wide range of websites and allows advertisers to buy, manage, and place display advertisements (“ads”) on websites, including banner, overlay, and rich media ads. Display advertising is typically managed by a company's marketing team or a third-party ad agency to drive both brand awareness and direct response initiatives. Display advertising is among the most common form of digital advertising.

Mobile advertising helps companies advertise on mobile devices such as smartphones and tablets, allowing advertisers to buy, manage, and place mobile ads, including mobile banner and video ads, interstitial ads that take up a full screen of a device, or ads that appear in mobile applications.

Social media advertising software companies advertise on social media sites such as Facebook, Twitter, and LinkedIn, allowing advertisers to buy, manage, and place social ads to reach the wide-spanning audiences using these sites. Social media advertising includes both first-party and third-party platforms. First-party platforms are those offered by the social media site directly, giving advertisers direct access to offerings available on the sites, and are typically used by small and mid-market businesses or those new to social media advertising. Third-party platforms integrate with social networks and typically offer more streamlined workflows, better scalability, and access to more than one social network.

Video advertising products allow advertisers to buy, manage, and place video ads on websites. Video advertising functionality may be offered through a best-of-breed product but is more commonly bundled into a cross-channel platform that may also possess capabilities for search, display, mobile, or social media advertising.

Quality advertising preserves a high-value dialogue between the advertiser and the end-user. This is achieved by the current ad paradigms by focusing on the content delivered from data consuming activities. However, the users are served with ads chosen by the company's marketing team or ad agency based on the targeted demography, the user's data consumption pattern, social engagement habits, or a combination of them. This subjects users to redundant and irrelevant ads that negatively disrupt their digital experience and consume costly bandwidth on their digital devices. As a result, users increasingly eschew ads via ad-blocker, private browsing, and other analogous filtering techniques. Additionally, with the current forms of advertising, the operators of the ad platforms are being compensated to select and deliver ads to users. This arrangement further aggravates the imbalance in the reward dynamics with users, marginalizing their incentives to meaningfully engage with the ad messaging and brands.

These issues with the current advertising paradigm are not isolated to just the users. Advertisers and brands are paying for vast numbers of display ads that are either unwanted or fraudulently generated. Much of the ad dollar return on investment (“ROI”) for mobile and desktop engagement is now being called into question by advertisers, realizing that that the current digital ad model does not deliver the anticipated value. In extreme cases, the ads may inadvertently harm the reputations of advertisers and brands by causing the users to resent being subjected to irrelevant content at inopportune times.

Longer term, the ad industry and advertisers can no longer expect users to view, let alone engage with, ads that do not reward them directly, or are misaligned with their experiences and values. The future of digital advertising belongs to those who can create and deliver an outstanding value proposition for mobile and desktop users, and for sponsoring advertisers. An intuitive, transparent, and fair platform that empowers direct engagement among the users and advertiser communities will emerge as the prevailing standard.

### SUMMARY OF THE DISCLOSURE

An embodiment of the present disclosure provides a method and system for a user to select ad contents used to enhance communication transactions and be directly rewarded by an advertiser. An advertiser provides a client system with information about an ad campaign, including ad targeting preferences, ad contents, reward offers, and operational parameters. The client system sends this information to a server system, which creates a unique campaign identifier and allocates data storage. The server system stores and indexes the supplied ad campaign information.

A user provides a client system with the user's engagement preferences, including categories of brands and contents, as well as the desired rewards. The client system sends this information to the server system, which produces an account associated with the user and stores the associated information.

A user initiates a communication transaction on a client system. The client system sends to the server system information that identifies the sending and receiving users, the type, amount, and denomination of an asset remittance, and the content of the communication. The server system produces the account of the sending user and retrieves the engagement preferences stored therein. Using this information and the information from an asset remittance request, the server system produces an identifier for a pending transaction and creates a list of matching offers associated with the most relevant campaigns' ad targeting preferences. The server system sends the list of offers and pending transaction identifier to the client system for display to the sending user. The sending user selects and provides the client system with a most suitable offer. The client system identifies the offer to the server system, which enhances the pending transaction by inserting into it the contents and reward specified in the offer. The server system sends the pending enhanced transaction to the client system to request for a confirmation by the sending user. The sending user provides the client system the confirmation, and the client system relays it to the server system. Using its internal component or a third-party system, the server system posts the enhanced pending transaction to the account of the recipient. A client system receives a notification of an incoming enhanced transaction and alerts a receiving user. The receiving user by way of the client system accepts and engages with the ad contents from the enhanced transaction. The client system sends to the server system a confirmation of the acceptance, which commits the asset remittance (if any) and transmits the rewards associated with the campaign's offers to the sending user's and receiving user's accounts.

### BRIEF DESCRIPTION OF THE DRAWINGS

FIG. 1 is a block diagram illustrating an embodiment of the disclosed system for rewarding users for direct engagement in an enhanced communication and remittance network.

FIG. 2 is a flow diagram of the service that enables e-mail communication from one user to another user to be enhanced with ad content, and that rewards both users for confirmed engagement.

FIG. 3 is a flow diagram of the service that enables asset remittance from one user to another user to be enhanced with ad content, and that rewards both users for confirmed engagement.

FIG. 4 is a screenshot illustrating the client user interface in one embodiment that is invoked by a user through an e-mail browser to remit an asset.

FIG. 5 is a screenshot illustrating the client user interface in one embodiment for a user to specify the recipient, type of asset, and amount to remit.

FIG. 6 is a screenshot illustrating the client user interface in one embodiment that enables a user to accept or decline an incoming remittance.

FIG. 7 is a screenshot illustrating the client user interface in one embodiment that acknowledges a remittance acceptance by a receiving user.

FIG. 8 is a screenshot illustrating the client user interface in one embodiment that acknowledges a remittance rejection by a receiving user.

FIGS. 9A and 9B illustrate different options for crafting stamps in one embodiment.

FIGS. 10A and 10B illustrate, respectively, a prototypical stamp and a stamp book in one embodiment.

FIG. 11 is a screenshot illustrating the wallet in the client user interface.

FIG. 12 is a screenshot illustrating the profile setting in the client user interface.

### DETAILED DESCRIPTION OF PREFERRED EMBODIMENTS

The disclosed method and system enables users to select brand and ad contents with which to engage in communication transactions and be directly rewarded. In doing so, the method and system implement a novel approach to customer targeting, which has traditionally been the role of ad agencies and companies. Ad agencies and companies serve a user with redundant and irrelevant ads due to lack of insight about the user's brand and contents preferences. However, a peer of the user does not suffer this disadvantage. Providing the method and system enabling the peer to select and serve ad contents to the user shifts the control and decision of which ad content to serve and whom to target away from the ad agencies and aggregators and toward the peers of users. This reduces the number of unwanted ads and improves the users' digital experience.

Also, in contrast to traditional paradigms that compensate third-parties to deliver ads to users, the disclosed method and system allow advertisers to directly reward users for their engagement. This motivates users to participate in more meaningful engagement with brands, reduces ad fraud for advertisers, and provides users with better communication experience.

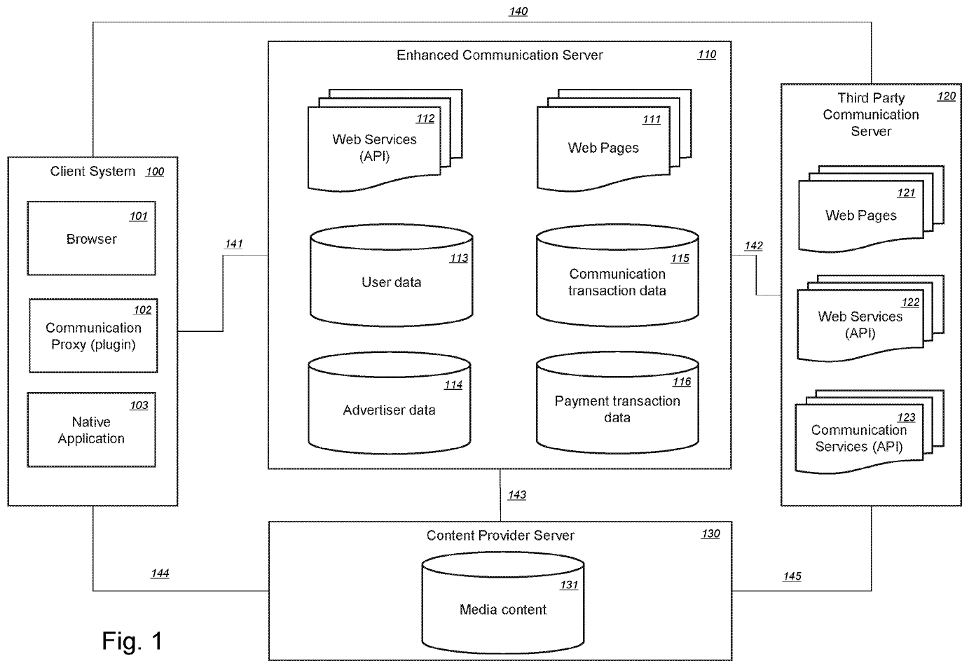

FIG. 1 is a block diagram illustrating a preferred embodiment of the disclosed system for rewarding users for direct engagement in an enhanced communication network. This embodiment supports a client system 100 accessing a server system or an enhanced communication server 110 over an Internet communication link 141, client system 100 accessing a third-party communication server 120 (such as Google, Gmail, or Yahoo Mail) over an Internet communication link 140 to facilitate communication among users, an enhanced communication server 110 accessing third-party communication server 120 over an Internet communication link 142, and a content provider server 130 supplying media content 131 to client system 100 over an Internet communication link 144, to enhanced communication server 110 over an Internet communication link 143, and to third-party communication server 120 over an Internet communication link 145. Servers 100, 110, 120, and 130 are implemented with communication signal interfaces to provide the communication links to one another.

Client system 100 using a browser 101 accesses services of enhanced communication server 110 and third-party communication server 120 via web pages 111 and 121, respectively. When allowed by a certain browser 101 (such as Google Chrome), client system 100 can also access the services of servers 110 and 120 by way of a communication proxy 102 (such as a browser plugin). Additionally, client system 100 can also access servers 110 and 120 via web services 112 and 122, respectively, and communication services API 123 (such as POP) by way of a native application 103. Native application 103 can be one of a desktop or mobile application executing on client system 100. Client system 100, enhanced communication server 110, and third-party communication server 120 access media content 131 from content provider server 130 via web services or content access API.

Enhanced communication server 110 provides services to client system 100 for a user and an advertiser to register new account, for an advertiser to create and manage an ad campaign, for a user to set and modify engagement preferences, for a user to initiate and receive enhanced communication transaction, for enhancing communication transaction, for relaying or delivering enhanced communication, and for relaying or delivering rewards to users for participating. As a consequence of the services provided, the server 110 stores and updates data including user data 113, advertiser data 114, communication transaction data 115, and payment transaction data 116. In this preferred embodiment, server 110 uses the third-party communication server 120 to authenticate the identity of a new or existing communication user. Server 110 also enhances a pending communication transaction from the sending user with the campaign's ad content and reward, and relays the enhanced pending communication transaction to third-party communication server 120 to be delivered to the receiving user. Upon a successful engagement, defined as an event in which the receiving user views or interacts with the ad content in the process of accepting the communication transaction, server 110 delivers rewards in the form of tokens to the sending and receiving users. In this preferred embodiment, the reward remuneration service (not shown) is internal to enhanced communication server 110.

In another embodiment, the form of reward may include fiat currency, digital cryptocurrency, or third-party tokens. In this case, server 110 relays the rewards delivery to an external remuneration service supporting the form of reward under consideration. As examples, for rewards paid in fiat currency, server 110 relays the rewards delivery to banks and financial institutions. For rewards paid in digital currency, server 110 relays the rewards delivery to public crypto network or crypto exchanges. For rewards paid in third-party tokens, server 110 relays the rewards delivery to company or network in operation and management of the tokens. In a further embodiment, server 110 may include a user authentication and communication service that authenticates new and existing communication users, as well as creates and delivers a communication transaction to them.

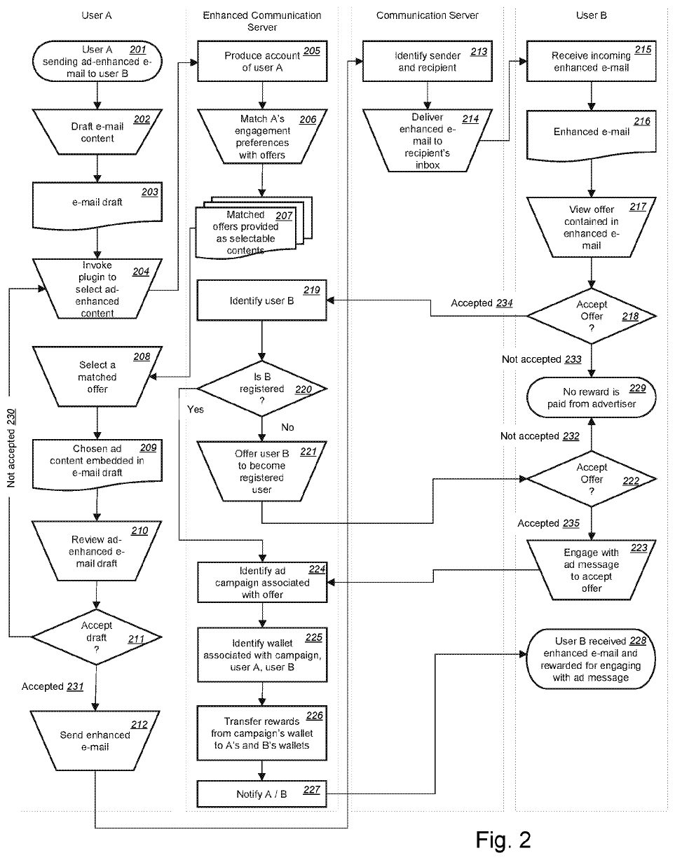

FIG. 2 is a flow diagram of the preferred embodiment that enables a user to send e-mail communication enhanced with ad content to another user, and that rewards both users for confirmed engagement. In step 201, user A contemplates sending an enhanced e-mail to a user B. In step 202, user A drafts the e-mail content and produces an e-mail draft 203. User A invokes a browser plugin to select ad-enhanced content in step 204. A User A identifier is sent to enhanced communication server 110, producing the account of user A in step 205. (Another embodiment may include the e-mail content in this step.) The enhanced communication server 110 retrieves user A's engagement preference from the account (and optionally the e-mail content) and uses a matching engine to perform a match 206 of user A's preferences to available offers and thereby produce a list of offers 207 selectable by user A. In step 208, user A selects the ad content from one of the offers based on a number factors of user A's choosing, including the type and amount of reward offered, to whom the rewards are paid (e.g., user A, user B, or both), and the ad content's relevance and appropriateness for user B (as best understood by user A given user A's knowledge of user B). The ad content from the offer is embedded into e-mail draft 203 to produce an enhanced e-mail communication 209. User A reviews the final ad-enhanced e-mail draft in step 210, and decides in step 211 whether to accept the final ad-enhanced e-mail draft as it appeared. If not accepted in step 230, user A returns to step 204 to repeat the process. If accepted in step 231, user A sends the enhanced e-mail in step 212. Third-party communication server 120 identifies the sending user and receiving user of the e-mail communication in step 213, and delivers the enhanced e-mail to the recipient (user B) in step 214. In step 215, user B receives the incoming enhanced e-mail message 216. User B views the offer contained in the e-mail message in step 217 and decides in step 218 whether to accept the offer. If not accepted in step 233, the process is completed in step 229, and no further action takes place. If accepted in step 234, the enhanced communication server 110 identifies user B in step 219 and checks to determine whether user B is a registered user in step 220. If yes, enhanced communication server 110 produces the ad campaign associated with the offer in step 224, as well as the wallets associated with the campaign, user A, and user B in step 225. Enhanced communication server 110 then transfers rewards from the campaign's wallet to user A's wallet and user B's wallet in step 226, and sends a notification to both users A and B in step 227. The process concludes in step 228, with the successful engagement of user B receiving the ad-enhanced e-mail from user A and rewards paid to both of them. If user B is not a registered user, enhanced communication server 110 offers user B an opportunity to become a registered user in step 221. User B decides in step 222 whether to accept the registration offer. If user B declines in step 232, the process again completes in step 229. If user B in step 235 accepts the registration offer and in step 223 engages with the ad content as part of the acceptance of the e-mail communication, the flow continues to step 224 as previously described.

As contemplated by the present disclosure, any kind of digital asset remittance is a form of communication for the paying user to convey the intent and purpose of payment and for the receiving user to decide as to whether to accept the payment. As such, a purpose of the preferred embodiment is to enhance and reward remittance communication activities.

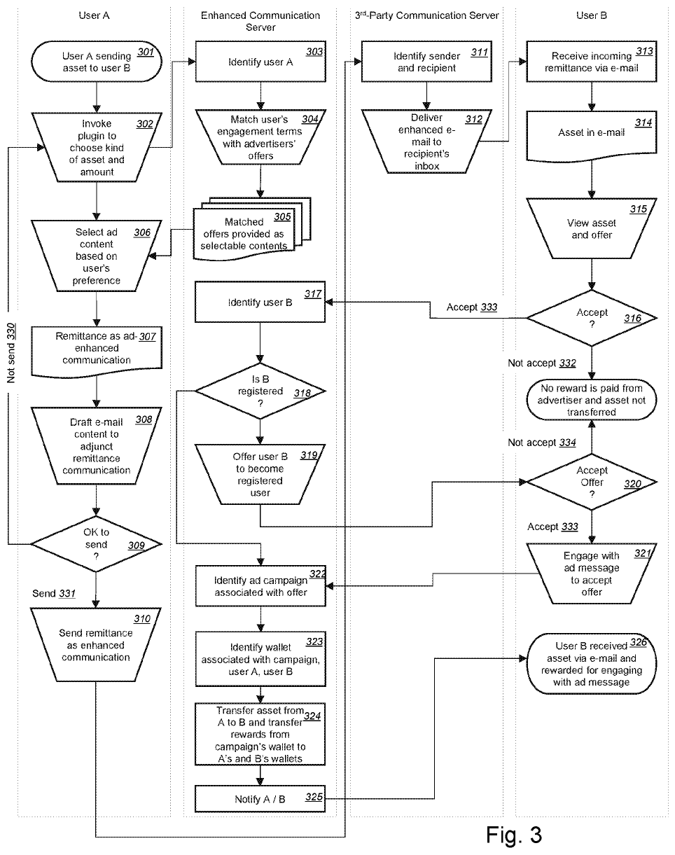

FIG. 3 is a flow diagram of the preferred embodiment that enables a user to remit crypto asset as ad-enhanced communication to another user, and rewards both users for confirmed engagement. In step 301, user A contemplates remitting crypto asset in an enhanced communication to user B. In step 302, user A invokes a browser plugin to choose the kind of asset to remit and the amount. A User A identifier is sent to enhanced communication server 110, producing the account of user A in step 303. In step 304, enhanced communication server 110 retrieves A's engagement preference from the account and uses a matching engine to perform a match 304 of user A's engagement terms with advertisers' offers and thereby produce a list of offers 305 selectable by user A. In step 306, user A selects the ad content from one of the offers based on a number factors of user A's choosing, including the type and amount of reward offered, to whom the rewards are paid (e.g., user A, user B, or both), and the ad content's relevance and appropriateness for user B (as best understood by user A given user A's knowledge of user B). The ad content from the offer and details of the remittance are used to produce the ad-enhanced communication 307. User A drafts optional e-mail content as an adjunct to the remittance in step 308 and checks whether the remittance is ready to send in 309. If not ready to send in step 330, user A returns to step 302 to repeat the process. If ready to send in step 331, user A sends the remittance as an enhanced e-mail communication in step 310. Third-party communication server 120 identifies the sending user and receiving user of the e-mail communication in step 311, and delivers the enhanced e-mail to the recipient (user B) in step 312. In step 313, user B receives the incoming remittance as enhanced e-mail message 314. User B views the asset and offer from the remittance contained in the e-mail message in step 315 and decides in step 316 whether to accept the offer. If not accepted in step 332, the process is completed, and no further action takes place. If accepted in step 333, enhanced communication server 110 identifies user B in step 317 and checks to determine whether user B is a registered user in step 318. If yes, enhanced communication server 110 produces the ad campaign associated with the offer in step 322, as well as the wallets associated with the campaign, user A, and user B in step 323. Enhanced communication server 110 then transfers the asset from user A's wallet to user B's wallet, and rewards from the campaign's wallet to user A's wallet and user B's wallet in step 324 and sends a notification to both users A and B in step 325. The process concludes in step 326, with the successful engagement of user B receiving the remittance as enhanced e-mail communication from user A and rewards paid to both of them. If user B is not a registered user, enhanced communication server 110 offers user B an opportunity to become a registered user in step 319. User B decides in step 320 whether to accept the registration offer. If user B declines in step 334, the process again concludes. If user B accepts in step 333, the registration offer and in step 321 engages with the ad content as part of the acceptance of the remittance e-mail communication, the flow continues to step 322 as previously described.

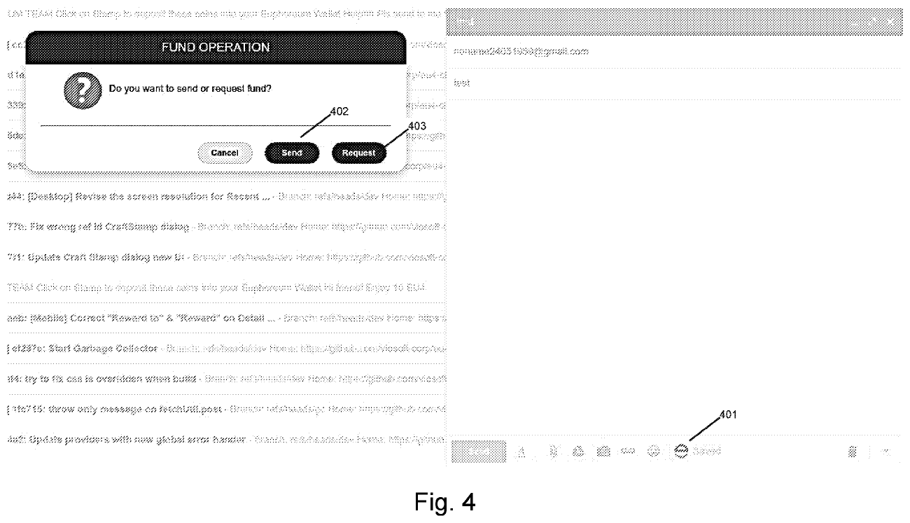

Client system 100 using a browser 101 accesses services of enhanced communication server 110 and third-party communication server 120 via web pages 111 and 121, respectively. When allowed by a certain browser 101 (such as Google Chrome), client system 100 can also access the services of servers 110 and 120 by way of communication proxy 102 (such as a browser plugin). FIG. 4 is a screenshot illustrating the client user interface in one embodiment that is invoked by a user through an e-mail browser to remit an asset. A button 401 is an extension to the Gmail browser interface made available through a Chrome browser plugin. A user clicking on button 401 activates the dialogue, providing the user with the option to choose an asset remittance send 402 or an asset remittance request 403.

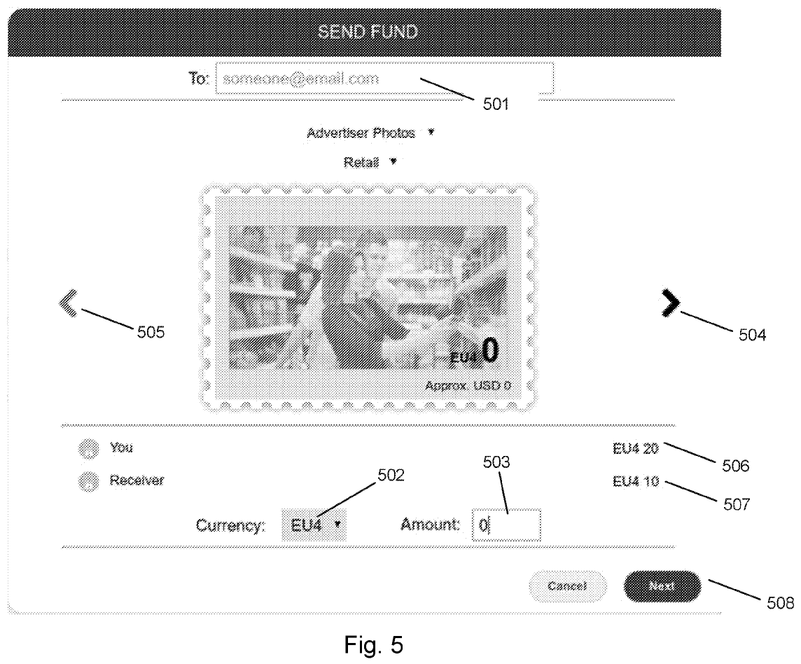

FIG. 5 is a screenshot illustrating the client user interface in one embodiment that is invoked by a user selecting the option to send asset remittance 402. The user specifies an e-mail address 501 of the recipient, a type of asset 502 to remit, and an amount 503. The user uses controls 504 and 505 to scroll through and view different offers generated and sent by enhanced communication server 110. The ad content of each offer, in this case an image, is rendered and displayed to the user as a stamp, with the type and amount of the remittance impressed on the image. Also for each offer, the amount of reward shown will be paid to the sending user (“You”, 506) and the receiving user 507. The type of rewards in this case is a utility token called “EU4”. The user selects the most suitable offer that meets the user's needs and presses “Next” 508 to proceed to a display (not shown) that makes final the remittance and prompts the user for the confirmation to send.

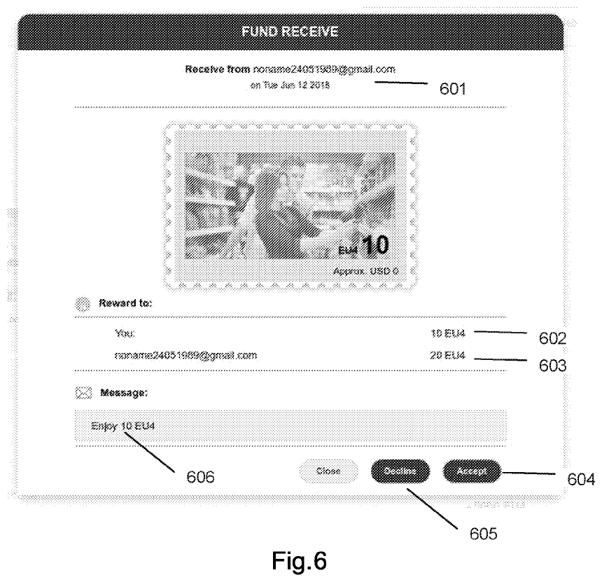

A client system receives a notification of an incoming enhanced transaction and alerts a receiving user. FIG. 6 is a screenshot illustrating the client user interface in one embodiment that enables a user to accept or decline an incoming remittance. The identity of the sending user and time of remittance is shown in 601. The amount and type of reward to the receiving user (“You”, 602) and the sending user 603 are shown, together with the message 606 from the sending user. The receiving user has the option to accept 604 the remittance (e.g., 10 EU4 as shown in the stamp impression) and further gain a reward of 10 EU4, 602, or decline 605 and receive neither the remittance nor the reward. Should the receiving user decide to accept, an additional reward (20 EU4, 603) is paid to the sending user as remuneration from advertiser to the sending and receiving users for their endorsement.

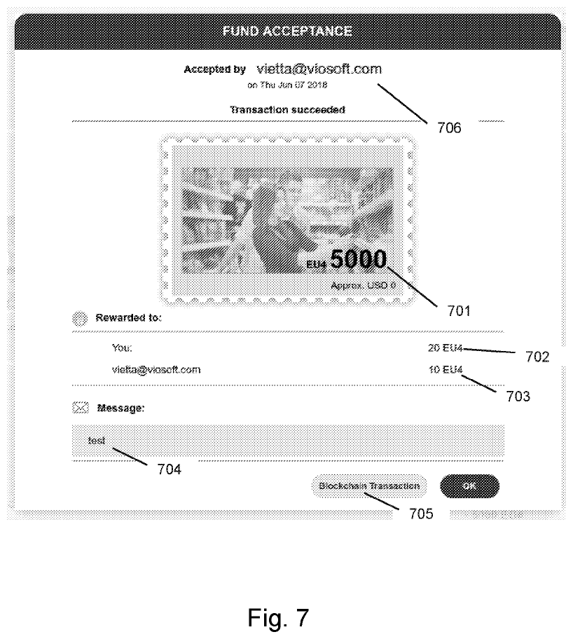

A client system receives a remittance acceptance notification and alerts a sending user. FIG. 7 is a screenshot illustrating the client user interface in one embodiment that notifies the remittance acceptance by a receiving user. Reference numeral 706 indicates the identity of the receiving user and time of acceptance. Reference numeral 701 indicates the type and amount of asset the user received and accepted, which are impressed on an ad message from the offer selected by the sending user. Reference numeral 702 indicates the reward paid to the sending user, and reference numeral 703 indicates the reward paid to the receiving user. Reference numeral 704 indicates the message originally crafted by the sending user as part of the remittance transaction. In another embodiment, reference numeral 704 may indicate a message crafted by the receiving user at time of acceptance, (e.g., “Was the remittance amount correct/sufficient?”, “Would you endorse the brand represented by the ad image?”). When actuated, button 705 displays the detailed records of the transaction (e.g., in the format of a cryptographic blockchain) when clicked on.

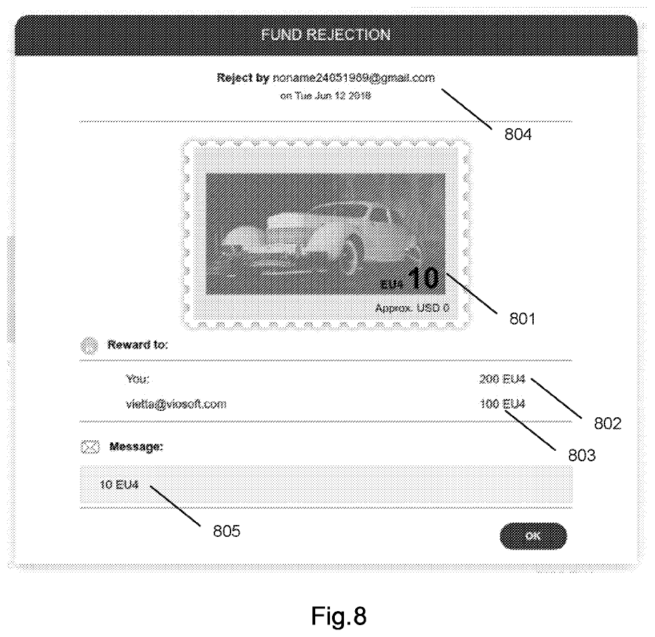

A client system receives a remittance rejection notification and alerts a sending user. FIG. 8 is a screenshot illustrating the client user interface in one embodiment that notifies the remittance rejection by a receiving user. Reference numeral 801 indicates the type and amount of asset remitted, and the ad content used to enhance the remittance. Reference numeral 804 indicates the identity of the receiving user and time of rejection. Reference numerals 802 and 803 indicate the reward that would have been paid to the sending user and receiving user had the receiving user accepted the remittance. Reference numeral 805 indicates the message originally crafted by the sending user as part of the remittance transaction. In another embodiment, reference numeral 805 may indicate a message crafted by the receiving user at a time of rejection (e.g., citing the reasons why the remittance was rejected), or the response from the receiving user to a questionnaire served at the time of rejection (e.g., “Was the remittance amount correct/sufficient?”, “Would you endorse the brand represented by the ad image?”).

Offer embodiments of the present disclosure can further enable deeper and more meaningful interaction with ad content and brands in the following manner. When a receiving user receives and views the offer in the process of deciding whether to accept the communication transaction, the ad content associated with the offer can include:

(1) a multimedia (video, audio, or both) stream containing the ad message from an advertiser. A user is not permitted to act on the incoming communication transaction until a certain condition is met (e.g., minimum amount of playback time reached, interaction with certain visual cue of the multimedia stream at specific time); or

(2) an interactive game, question and answer challenge, questionnaire, survey that requires a user to successfully engage before a reward from the offer is given. Depending on the response, degree and quality of engagement from the user, the ad message may serve the user further offers relevant to the ongoing dialogue, either immediately or at a later time (e.g., the offer on behalf of a hiring agency contains questionnaire intended at identifying receiving users suitable for employment. By successfully answering questions that are relevant to the field in question from an automated questionnaire, the user is provided follow-up offers from the ad campaign to view opportunities from different employers seeking workers meeting the user's qualification). Similarly, the nature of the reward (type, amount) can further be determined based on the degree and quality of the receiving user's engagement.

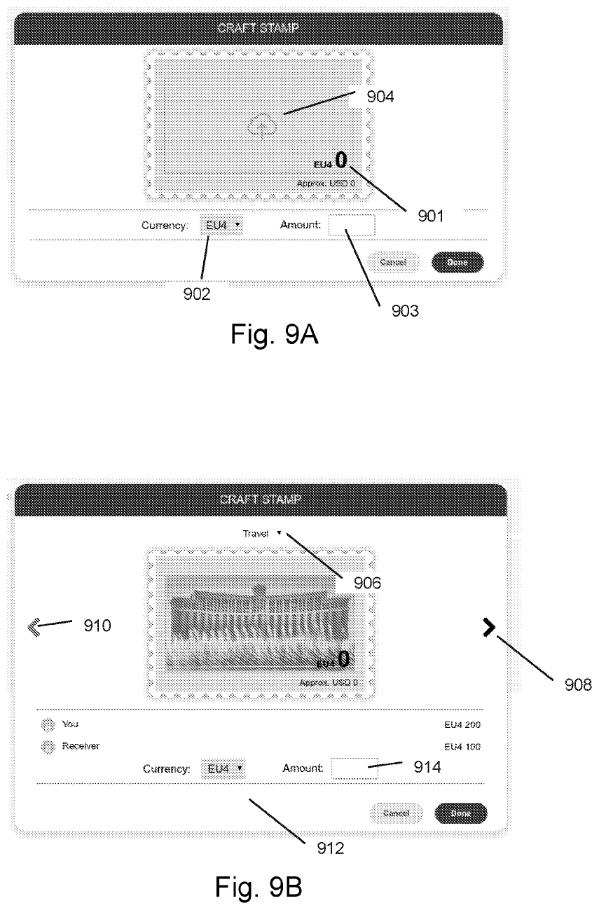

In the preferred embodiment, the ad content of each offer, in this case an image, is rendered and displayed to the user as a stamp, with the type and amount of the remittance impressed on the ad image. FIGS. 9A and 9B illustrate different options for crafting a stamp. In FIG. 9A, a sending user selects a type 902 and an amount 903 of remittance to be impressed on the image. The ad image can be any given image that the sending user can upload by clicking on a button 904. An additional image or overlay from the offer may be inserted into the stamp, if rewards are desired. The sending user clicks on “Done” to create the stamp. In FIG. 9B, a sending user selects the category 906 and uses controls 908 and 910 to scroll and select an ad image. Rewards associated with the sending and receiving users are shown below. The sending user selects a type 912 and an amount 914 of remittance to be impressed on the image and clicks on “Done” to create the stamp.

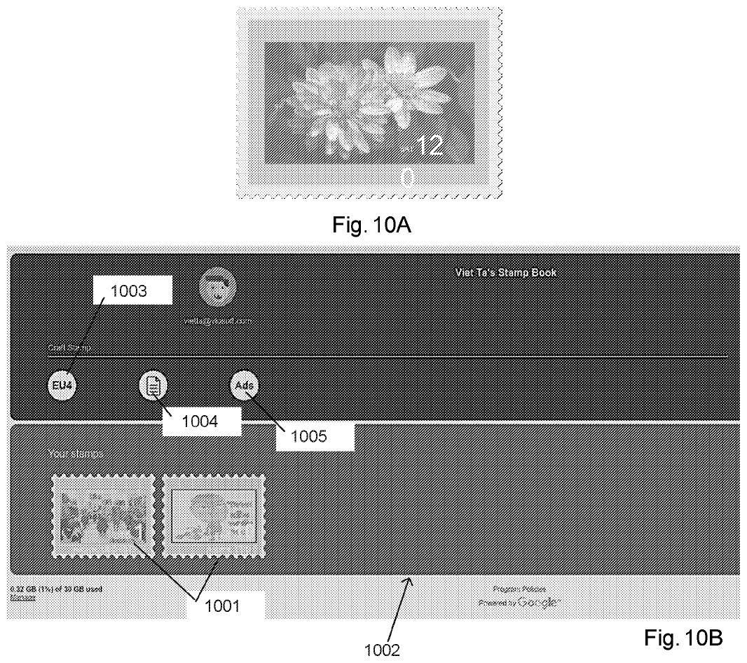

In the preferred embodiment, the contemplated communication by the sending user is enhanced with artistic stamp incentivized rewards. FIGS. 10A and 10B illustrate, respectively, a prototypical stamp and a stamp book in the preferred embodiment. FIG. 10A shows a prototypical stamp containing an artistic image that can be used to represent a brand or messaging associated with the promotion of a brand. The type and amount of the remittance is impressed over the image in an area of the stamp in such a manner that optimizes legibility for the viewer. A user creates a stamp in the process of drafting an enhanced communication transaction, as described elsewhere in this disclosure. For frequently used transactions, the user can craft a number of different stamps 1001 ahead of time and store them in a stamp book 1002 shown in FIG. 10B. Using the stamp book, the user can craft stamp using (ad) content from the enhanced communication server (EU4, 1003), from the user's own photo library 1004, or from advertiser 1005.

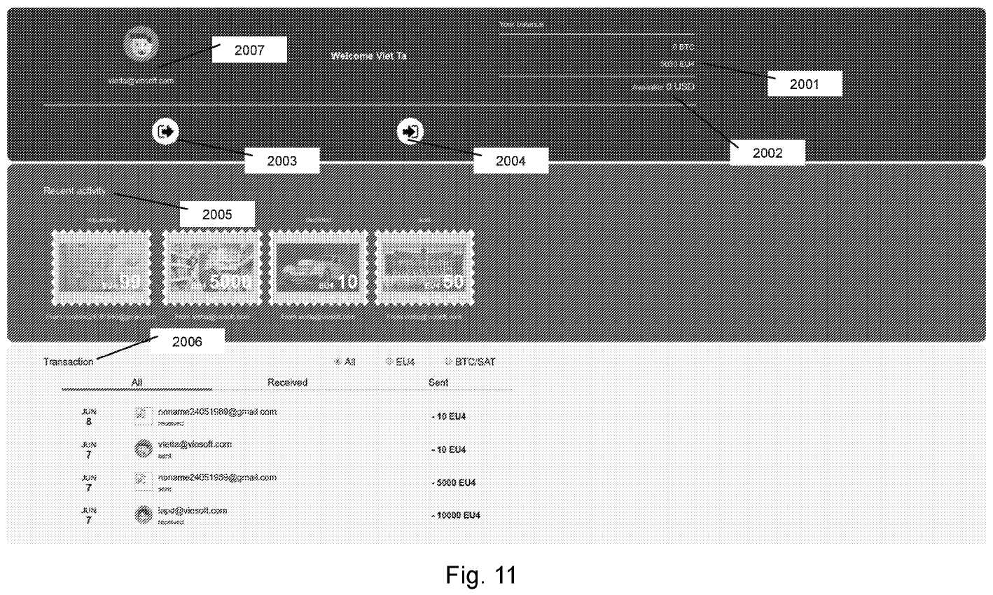

In the preferred embodiment, enhanced communication system 110 includes a remittance processing component that manages payment among the users and the advertisers. In that respect, the system produces a wallet for each registered user and advertiser. The wallet is used to store, view, and remit assets (e.g., fiat and digital currencies, utility tokens) among users and advertisers. FIG. 11 is a screenshot illustrating a wallet in the client user interface. Reference numeral 2007 indicates the identity (e-mail address) of the wallet owner. A balance summary of different assets 2001 in the wallet provides an estimated available balance in fiat currency (in this case USD) based on the currently available public exchange rate. A button 2003 opens the asset remittance sending user interface (FIG. 5). A button 2004 opens the asset remittance requesting user interface (not shown). A Recent activity 2005 shows a list of pending transaction, including assets received but not yet accepted or rejected by the wallet owner, and assets sent by the wallet owner but not yet accepted or rejected by the recipient. A Transaction 2006 shows a list of recent confirmed transactions, which in this case is sorted by date.

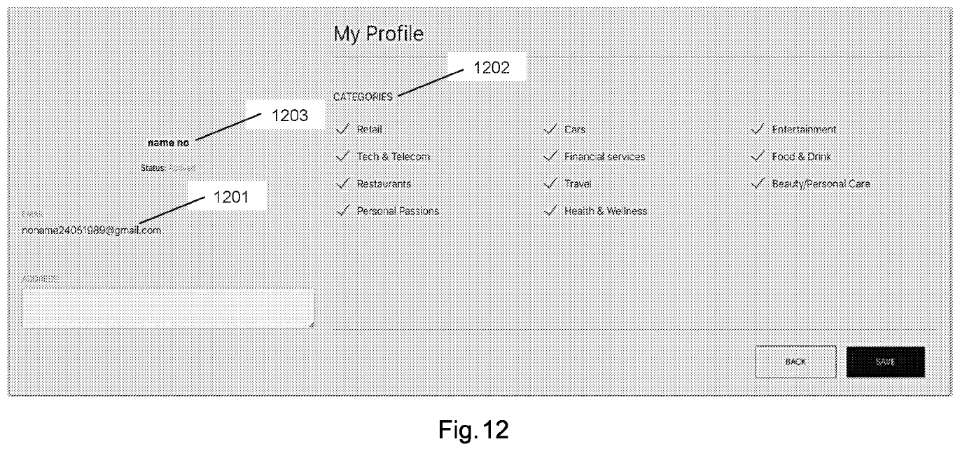

In the preferred embodiment, a user provides client system 100 with the user's engagement preference, including categories of brands and contents, and the desired rewards. Client system 100 sends this information to a server system, which produces the account associated with the user and stores the associated information. FIG. 12 is a screenshot illustrating the profile setting that enables the user to provide engagement preference in the client user interface. Reference numeral 1203 indicates the name of a registered user, along with the registered user's e-mail address 1201. A checked list of categories 1202 allows the user to select one or more categories of ad content made available for use in a subsequent communication transaction initiated by the user. Another embodiment of the current disclosure may include additional information in the client user interface to help the sending user more accurately define the user's engagement preference.

One-to-many communication platforms (e.g., Twitter), traditional mobile network messaging platforms, or over-the-top messaging platforms are in many respects similar to e-mail communication. All have the ability to create and deliver text, image, and video among users. Another embodiment of the present disclosure may combine functionalities of email, tweet, mobile messaging, and over-the-top messaging into a single client system to offer the communicating users with a unified and enhanced communication experience regardless of the third-party communication service being used.

As another example, the preferred embodiment at the simplest level can sufficiently enable an ad reward platform that integrates e-mail with wallet. Users are able to select and deliver quality and relevant ad messages to their peers as part of their communication, asset remittance, or both, activity, and in doing so benefit from the enhanced experience and rewards associated with brand engagement. Starting with e-mail, this is achieved by combining and embedding artistic “stamps” that serve to elevate the context and contents of messages into communication transactions in the following manner.

A sending user may select a qualifying ad image as stamp from a stamp booklet in the inbox to craft an e-mail to a receiving user and, in exchange, is compensated with a number of rewards from the brand associated with the ad message. The e-mail receiving user receives a separate reward for acknowledging and accepting the endorsed stamp. Similarly, a payer may choose an advertiser's ad image to accompany a remittance of assets in the form of a stamp and receive rewards, along with the receiving user of the assets.

FIG. 10A depicts an example of a stamp created with image from an advertiser on behalf of a brand. The image is made available to the users' stamp book in their inboxes in accordance to their selected preference of brand category. A user may select the image to mint a stamp for inclusion in an e-mail communication or asset remittance. For the case in which a stamp is used as embellishment to the e-mail communication (as well as to earn rewards), the recipient may handle the received stamp in either of two ways: accept the stamp, and in doing so, triggers reward payment to the recipient's wallet and the sending user's wallet, or choose to ignore the message, stamp, or both. In this case, the stamp is discarded by default, and no reward is paid.

For the case in which the minted stamp is used to remit asset, the recipient's choices are accept the stamp or ignore the remittance. Accepting the stamp triggers reward to the recipient and the sending user. The asset in the remittance is deposited into the recipient's wallet and the stamp (without any asset associated) is stored in the recipient inbox's stamp book. Ignoring the remittance results in refund of the asset to the sending user's wallet after a period of time. No reward is paid.

Advertisers can create and launch one or more ad campaigns, each with different engagement and reward. Associated with each ad campaign is a total allocated reward budget, the amount of reward paid to the sending user and receiving user for each successful engagement, and various other attributes that control aspects of reward activity and payment. The permutation of ad campaign options and attributes enables a rich variety of powerful use-cases for brands and advertisers, outlined in the following examples.

An agency starts a campaign with a total budget of 100,000 reward tokens. The agency creates multiple artistic images, which are organized into several categories. The reward paid for each successful engagement is 100 tokens to the sending user and 100 tokens to the receiving user. At launch, the images are made available to users whose engagement preferences match those offered by the agency. As the users successfully engage in e-mail or remittance activities using stamps minted with images from the agency's campaign, rewards are paid to the users' wallets. The campaign expires after a number of days, or when the total budget runs out, whichever comes first.

In a variation, an agency may purpose an ad campaign to specific demographics by targeting insight that existing users have about their (non-participating) peers. In a hypothetical scenario, a campaign is launched to target owners of luxury vehicles by rewarding sending users to utilize the agency's automotive ad images to craft stamps for use in e-mail communication, crypto remittance, or both, to qualifying peers. Due to the highly focused nature of the campaign, the agency will pay significant rewards for confirmed engagement, which may be as simple as a having the receiving user of one of the stamps check a box confirming ownership of a luxury vehicles as well as identifying the make and model of the vehicle.

The above examples demonstrate that the content providers (advertisers) do not send stamps directly to e-mail users. Rather, they simply make ad-endorsed images available to an individual user's account in keeping with the user's selected categorical preferences. Subsequently, the user may craft stamps by selecting the ad images that are most relevant to the context and content of the e-mail communication, asset remittance, or both.

The following is summarizes the disclosed method for a user to select ad content used to enhance a communication transaction and be directly rewarded by an advertiser.

The method is carried out by receiving and fulfilling a request from an advertiser for creating a new account and providing information about the advertiser. This stage of the method entails receiving from an advertiser the request for creating the advertiser account, the request including the advertiser identity, e-mail, physical address, billing information; generating a unique identifier; creating and associating with the identifier, an account data storage location for an advertiser account; storing the information from the request into the data storage location for the advertiser account; and sending a confirmation response to the request.

The method is further carried out by receiving and fulfilling a request from a user for creating a new account and providing information about the user. This stage of the method entails receiving from a user the request for creating the user account, the request including the user identity and e-mail address; generating a unique identifier; creating and associating with the identifier, an account data storage location for a user account; storing the information from the request into the user account; and sending a confirmation response to the request.

The method is further carried out by receiving and fulfilling a request from an advertiser to create an ad campaign. This stage of the method entails receiving from an advertiser the request for creating the ad campaign, the request including the advertiser identifier, ad targeting preferences, one or more ad offer information, and operational parameters, the ad offer information including ad content and reward policy; using an advertiser identifier to produce an account associated with the advertiser; generating an ad campaign identifier; creating and associating with the identifier, an account data storage location for the ad campaign; storing the information from the request into the data storage location of the ad campaign; and, for each offer in the request, generating an offer identifier, creating and associating with the offer, a data storage location for the offer, storing the information from the offer into the data storage location for the offer; and sending a confirmation response to the request.

The method is further carried out by receiving and fulfilling a request from a user for setting or modifying the user's engagement preference. This stage of the method entails receiving from a user the request for setting or modifying the user's engagement preference, the request including the user identifier and the user's preference for one or more of: the type of ad contents (paid versus not), categories of brands represented by the ad contents, categories of contents served, desired amount of reward (if any) for each engagement; using the user identifier to retrieve the account; and setting or modifying the user's engagement preference from the account to the information from the request; and sending a confirmation response to the request.

The method is further carried out by receiving and fulfilling a request from a sending user for initiating a communication transaction. This stage of the method entails receiving from a sending user a request for initiating a communication transaction, the request including the user identifier, receiver identifier, type, amount, and denomination of the remittance, and content of the communication; using the user identifier to retrieve the account; retrieving the engagement preferences stored in the account; producing a list of offers from ad campaigns with targeting preferences that are determined to be most relevant to the user's engagement preferences; creating a unique transaction identifier for the request; sending a response to the user providing the transaction identifier and the list of offers, the user selecting an offer from the list of offers and sending an acknowledgement containing the selected offer identifier and the transaction identifier; receiving an acknowledgement from a user specifying the selected offer identifier, and the transaction identifier; retrieving the ad content and the reward policy associated with the offer identifier and the pending communication transaction associated with the transaction identifier; combining the ad content and reward policy with the communication transaction to produce an enhanced communication transaction; sending a request with the transaction identifier to the client system for confirmation; delivering the pending enhanced communication transaction to a communication server for delivery to the recipient; sending a confirmation response to the request.

The method is further carried out by receiving and fulfilling a request from a receiving user for accepting or rejecting a pending communication transaction. This stage of the method entails receiving a request from a receiving user for accepting or rejecting a pending communication transaction, the request including the receiving user identifier and pending transaction identifier; retrieving the reward policy associated with the offer identifier associated with the transaction identifier; committing the action associated with pending transaction, including any remittance activity from the sending user to the receiving user; performing the instruction specified in the reward policy, including any remittance activity to send payment reward from the advertiser to the sending user and to the receiving user; and sending a confirmation response to the request.

It will be apparent to skilled persons that many changes may be made to the details of the above-described embodiments without departing from the underlying principles of the invention. The scope of the present invention should, therefore, be determined only by the following claims.

1. A method of creating an ad campaign, comprising:
receiving from an advertiser a request for, and information detailing characteristics of, an ad campaign in which users are rewarded for initiating or receiving a communication transaction that is enhanced with ad contents selected by the users, the information including ad targeting preferences, ad contents, reward policy, and operational parameters;
using an advertiser identifier to produce an account associated with the advertiser;
generating an ad campaign identifier and creating for the account data storage locations for the ad campaign; and
storing the information from the request into the data storage locations of the ad campaign.

2. The method of claim 1, in which the ad targeting preferences include type of communication, context and content of a communication, or attributes of the user.

3. The method of claim 2, in which the type of communication includes one of more of e-mail, remittance, text message, voice, video call, or alternate realities.

4. The method of claim 2, in which the context and content of a communication includes one of more of phrases, keywords, semantics, or combination thereof.

5. The method of claim 2, in which the attributes of the user include one or more of the user's demographics, credit ranking, or purchase history.

6. The method of claim 1, in which the communication transaction includes sending and receiving of e-mail, text message, participating in voice or video call, participating in alternate realities, or participating in asset remittance.

7. The method of claim 6, in which the asset remittance includes fiat currency remittance, cryptocurrency remittance, reward points remittance, or tokens remittance.

8. The method of claim 6, in which alternate realities include one-to-one, one-to-many, and many-to-many communications in virtual reality (VR) or augmented reality (AR).

9. The method of claim 1, in which the ad contents include one or more of text, image, audio, video, virtual reality, or augmented reality.

10. The method of claim 1, in which the operational parameters include one or more of total budget for the ad campaign, duration of the ad campaign, or geographic target of the ad campaign.

11. The method of claim 1, in which the reward policy includes one or more of amount of payment, reward points, type of payment, or executable program code producing reward policy using targeting preferences and user engagement preferences as inputs.

12. The method of claim 1, further comprising producing an offer with ad content that can guide behavior and interaction the receiving user, the ad content including:
a multimedia stream containing an ad message from an advertiser to a receiving user, the receiving user being disallowed from further action against an incoming pending communication transaction until a minimum amount of playback time reached, a completed interaction with a certain visual cue of the multimedia stream at specific time, or both; or
an interactive activity that requires, from the receiving user, further action including a game, question and answer challenge, questionnaire, survey, or combination thereof.

13. A system for enhancing remittance and communication among users with advertiser contents selected by a sending user and for rewarding a receiving user for performing a confirmed transaction, comprising:
an advertiser signup and campaign management component processing a request by an advertiser to create an advertiser account, to create an ad campaign, to set or modify the targeting preference or operational attributes of an ad campaign, and to store and manage ad contents;
a user signup and preference management component processing a request by a user to create a user account and to set or modify the attributes and engagement preference of a user;
a matching engine that produces a set of offers associated with relevant campaign targeting preferences, in which content of an offer in the set includes an offer identifier, a reward policy, and ad content;
a remittance processing component that fulfills a payment transaction associated with a communication transaction and related reward payment activity, the communication transaction being initiated by a user and enhanced by ad content selected by the user from a set of matches generated by the matching engine;
a communication processing component that delivers a pending communication transaction from a sending user to a receiving user; and
a reward settlement component that uses the remittance processing component to credit and debit rewards associated with the communication transaction.

14. The system of claim 13, further comprising a communication signal interface for transmitting the communication transaction to a client system for acknowledgement by the client system and acceptance by the receiving user.

15. The system of claim 13, in which the communication processing component comprises an external third-party server providing communication services, an internal component to the system, or combination thereof.

16. The system of claim 13, in which the remittance processing component from the same location transmits remittance from the sending user to the receiving user and transmits rewards from the ad campaign to the sending user and the receiving user.

17. The system of claim 13, in which the remittance processing component transmits from one location remittance from the sending user to the receiving user and transmits from a separate location rewards from the ad campaign to the sending user and the receiving user.

18. The system of claim 13, in which the ad targeting preferences include type of communication, context and content of a communication, or attributes of the user.

19. The system of claim 18, in which the type of communication includes one of more of e-mail, remittance, text message, voice, video call, or alternate realities.

20. The system of claim 18, in which the context and content of a communication includes one of more of phrases, keywords, semantics, or combination thereof.

21. The system of claim 18, in which the attributes of the user include one or more of the user's demographics, credit ranking, or purchase history.

22. The system claim 13, in which the communication transaction includes sending and receiving of e-mail, text message, participating in voice or video call, participating in alternate realities, or participating in asset remittance.

23. The system of claim 22, in which the asset remittance includes fiat currency remittance, cryptocurrency remittance, reward points remittance, or tokens remittance.

24. The system of claim 22, in which alternate realities include one-to-one, one-to-many, and many-to-many communications in virtual reality (VR) or augmented reality (AR).

25. The system of claim 13, in which the ad contents include one or more of text, image, audio, video, virtual reality, or augmented reality.

26. The system of claim 12, in which the operational parameters include one or more of total budget for the ad campaign, duration of the ad campaign, or geographic target of the ad campaign.

27. The system of claim 13, in which the reward policy includes one or more of amount of payment, reward points, type of payment, or executable program code producing reward policy using targeting preferences and user engagement preferences as inputs.

28. The system of claim 13, in which the offer includes ad content that can guide behavior and interaction the receiving user, the ad content including:
a multimedia stream containing an ad message from an advertiser to a receiving user, the receiving user being disallowed from further action against an incoming pending communication transaction until a minimum amount of playback time reached, a completed interaction with a certain visual cue of the multimedia stream at specific time, or both; or
an interactive activity that requires, from the receiving user, further action including a game, question and answer challenge, questionnaire, survey, or combination thereof.

29. The system of claim 13, in which the remittance processing component comprises a third-party server providing remittance services.

30. The system of claim 29, in which the remittance services include bank, financial institution, or crypto exchange services.

31. The system of claim 13, in which the remittance processing component comprises a third-party system providing remittance services, a component forming part of the system, or combination thereof.

32. The system of claim 13, in which the communication processing component comprises a text-based communication system over a public telephone network or over-the-top utilizing an internet network that includes one-to-one communication or broadcast communication; or a voice-based communication system over a public telephone network or an over-the-top voice and video based communication system that includes a social-oriented communication system.

33. The system of claim 13, further comprising a client system for creating ad campaigns, specifying a user's engagement preferences, initiating a communication and receiving a communication, the client system including:
a display component for displaying and receiving information;
a campaign creating component used by an advertiser to input a request for creating the ad campaign and provide information including the advertiser identity, ad targeting preferences, ad contents, reward policies, and operational parameters;
an account creating component used by a new user to input a request for creating a new account and provide information about the user;
a user's engagement preferences setting component used by a user to input a request for setting or modifying the user's engagement preference, provide information detailing the characteristics of the request including the user identifier and the user's engagement preference including one or more of the type of ad contents, categories of brands represented by the ad contents, categories of contents served, desired amount of reward, if any, for each engagement;
a user's wallet management component used by a user to engage in remittance activity;
a communication initiating component used by a sending user to input a request for initiating a communication transaction, and information detailing the characteristics of the communication transaction including the sending user identifier, receiving user identifier, type, amount, and denomination of the remittance, and content of the communication; and
a pending communication processing component used by a user to input a request to accept or reject a pending communication transaction, and information detailing the request including the identity of the user and transaction identifier.

34. The client system of claim 33, in which the display component is a browser.

35. The client system of claim 33, in which the display component is a plugin to a browser.

36. The client system of claim 33, in which the display component is a native application operating on a desktop or mobile device.

37. The client system of claim 33, in which the communication initiating component combines functionalities of email, tweet, mobile messaging, and over-the-top messaging system into a single client.
